(19) United States
(12) Patent Application Publication
(10) Pub. No.: US 2025/0262846 A1
(43) Pub. Date: Aug. 21, 2025

(54) HDPE BARRIER EXTRUSION COATING & LAMINATION FOR FLEXIBLE PACKAGING STRUCTURES

(71) Applicant: Equistar Chemicals, LP, Houston, TX (US)

(72) Inventor: Emily A. Silber, Cinncinnati, OH (US)

(73) Assignee: Equistar Chemicals, LP, Houston, TX (US)

(21) Appl. No.: 19/048,343

(22) Filed: Feb. 7, 2025

Related U.S. Application Data
(60) Provisional application No. 63/556,091, filed on Feb. 21, 2024.

(51) Int. Cl. B32B 27/08; B32B 27/18; B32B 27/32; B32B 37/15

(52) U.S. Cl. CPC B32B 27/08; B32B 27/18; B32B 27/32; B32B 37/153; B32B 2250/04; B32B 2307/7244; B32B 2307/7246; B32B 2307/7376; B32B 2323/043; B32B 2323/046; B32B 2553/00

(57) ABSTRACT

A high density polyethylene-based composition for a barrier layer on extrusion coated flexible packaging is described. The high density polyethylene-based barrier layer is between about 20 to about 60% of the thickness of the flexible packaging. HDPE barrier layer can be extrusion coated as a barrier layer directly onto a substrate, or co-extruded with intermediate polymer layers onto a substrate.

### PRIOR RELATED APPLICATION

This application claims the benefit of priority to U.S. Provisional Application No. 63/556,091, filed on Feb. 21, 2024, which is incorporated here by reference in its entirety.

### FIELD OF THE INVENTION

The present disclosure relates generally to flexible packaging, and in particular, to flexible packaging having moisture barrier properties.

### BACKGROUND OF THE INVENTION

Flexible packaging is a type of packaging that can be customized to fit the shape and size of its contents. It is produced from paper, plastic, film, aluminum foil, or any combination of those materials, and includes bags, pouches, liners, wraps, rollstock, and other flexible products. Flexible packaging has many advantages including lightweight construction, cost-efficiency, and customizability. It has also been used to extend the shelf life of perishable goods while protecting them from damage. As such, flexible packaging has been found in a variety of industries including food and beverage, pharmaceuticals, personal care, pet products, and industrial supplies.

Flexible films, in particular, have been used as lightweight packaging with a substantially hermetic seal for shipping and storage of a variety of food products, including, for example, crackers, chewing gum, chocolate, cookies, cheese, sandwiches, biscuits, candy, juice, meat products, dry food goods (e.g. hot chocolate and instant potatoes) and dried fruits and vegetables.

In the last decades, flexible packaging with barrier properties have been achieved by utilizing foils or metallized films. While this has allowed for acceptable water vapor transmission rates (WVTR) and oxygen transfer rate (OTR), there exists a need to improve materials utilized for these types of packaging and reduce their effect on the environment.

### SUMMARY OF THE INVENTION

The present disclosure is directed to a flexible packaging that reduces or eliminates the need to use foils or metallized films while maintaining the same or better barrier properties. In particular, HDPE compositions are extrusion coated as barrier layer(s) in a flexible packaging structure to provide comparable moisture barrier to industry standard per ASTM F1249. An example of an extrusion coating with an HDPE barrier layer is shown in FIG. 1. In some embodiments, this flexible packaging had a WVTR of 1.25 (mil-g)(100 in²-day) or less at 20 mil die. In other embodiments, this flexible packaging had a WVTR of 2.0 (mil-g)(100 in²-day) or less at 50 mil die, or at a 30 mil die. This is as good as or better than flexible packaging that utilizes a foil barrier layer.

In more detail, a HDPE composition is extruded as a “core”, or barrier, layer used in flexible packaging along with a substrate layer and one or more other layers. The HDPE in the present disclosure has density between about 0.940-0.965 g/cc and a melt index between about 2-18 g/10 min. In some embodiments, a nucleated HDPE is used as the barrier layer. The HDPE composition can also include other additives such as acid scavengers, processing aids, and/or antioxidants.

In some embodiments, the HDPE composition is at least 20 to 60% of the total thickness of the flexible packaging. In other embodiments, the HDPE composition forms a layer that is at least 0.5 mil to about 4 mil. The nucleated HDPE was a core layer in this study.

The flexible packaging further includes a substrate. The HDPE core layer can be layered directly onto a substrate or onto an intermediate layer between the substrate and the HDPE core layer. In some embodiments, the intermediate layer is one or more low density PE (LDPE). Any LDPE can be used. In some embodiments, the LDPE has a melt index of about 5.6 g/10 min, and a density of about 0.923 g/cc. In some embodiments, the HDPE and LDPE are co-extruded onto the substrate layer. In other embodiments, the HDPE is sandwiched between and coextruded with an LDPE layer on both sides.

The present compositions and methods include any of the following embodiments in any combination(s) of one or more thereof:

A flexible packaging or container having the presently described HDPE composition coextruded with a polymeric intermediate layer, wherein the polymeric intermediate layer is coated to a flexible substrate.

A flexible packaging or container having the presently described HDPE composition sandwiched between two LDPE layers, wherein at least one LDPE is coated to a flexible substrate.

A flexible packaging or container having the presently described HDPE composition coextruded between two polymer layers, wherein at least one polymer is coated to a flexible substrate.

A flexible packaging or container having the presently described HDPE composition coextruded between two LDPE layers, wherein at least one LDPE layer is coated to a flexible substrate.

Any of the above packaging or containers, wherein the HDPE has a MI between about 2-18 g/10 min.

Any of the above compositions, methods, packaging or containers, wherein the HDPE has a density between about 0.940-0.965 g/cc.

Any of the above packaging or containers, wherein the substrate is paper, polymer films, or combinations thereof.

Any of the above packaging or containers, wherein the HDPE it at least about 0.5 mil to about 4 mil thick.

Any of the above packaging or containers, wherein the HDPE it at least about 20 to about 60% of the thickness of the packaging.

Any of the above packaging or containers, wherein the HDPE provides barrier properties to the packaging.

Any of the above packaging or containers, wherein the WVTR is less than 2 (mil-g)(100 in²-day), or less than 1.75 (mil-g)(100 in²-day), or less than 1.5 (mil-g)(100 in²-day).

Any of the above packaging or containers, wherein the WVTR is between greater than 0 to about 2 (mil-g)(100 in²-day).

Any of the above packaging or containers, wherein the WVTR is about 0 to about 2 (mil-g)(100 in²-day) or less.

Any of the above packaging or containers, wherein the WVTR is about 1.7 (mil-g)(100 in²-day) or less.

Any of the above packaging or containers, wherein the OTR is 21 (mil-g)(100 in²-day) or less.

Any of the above packaging or containers, wherein the OTR is greater than 0 to 21 (mil-g)(100 in²-day).

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

These and other features, aspects, and advantages of the present disclosure will become better understood with reference to the following description and appended claims, and accompanying drawing figure where:

FIG. 1 is an illustrative depiction of one embodiment of the presently described invention.

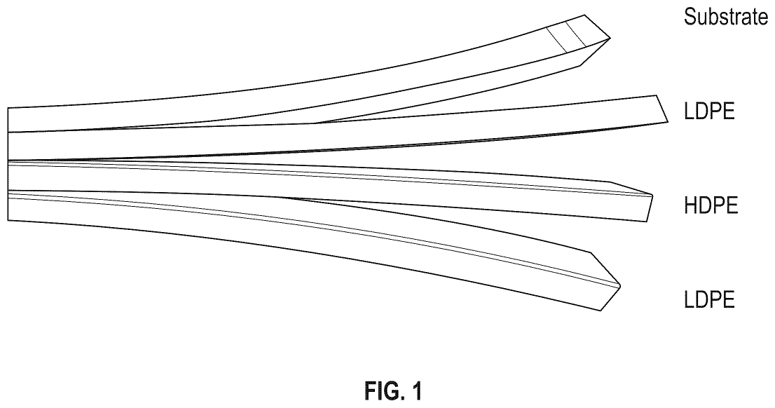

FIG. 2A depicts the WVTR results for a 30 mil Die.

FIG. 2B depicts the WVTR results for a 20 mil Die.

FIG. 3 is the WVTR for a 30% HDPE Core.

FIG. 4 is the WVTR for a 50% HDPE Core.

It should be understood that the various embodiments are not limited to the arrangements and instrumentality shown in the drawing figure.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

### Definitions

The terms “ethylene polymer” or “polyethylene” are used interchangeable and are intended to embrace, as alternatives, both a single ethylene polymer and an ethylene polymer composition, and encompasses both homopolymers and copolymers.

The comonomer or comonomers present in the ethylene copolymers are generally selected from olefins having formula CH₂═CHR wherein R is an alkyl radical, linear or branched, having from 1 to 10 carbon atoms. Specific examples are propylene, butene-1, pentene-1, 4-methylpentene-1, hexene-1, octene-1 and decene-1. In some embodiments, the comonomer is a vinyl acetate.

As used herein, “HDPE” means high density polyethylene—i.e., ethylene homopolymers and ethylene copolymers produced in a suspension, solution, slurry, or gas phase polymerization process and having a density in the range of 0.940 g/cm³ to 0.970 g/cm³.

As used herein, “LDPE” means low density polyethylene—i.e., ethylenc homopolymers and ethylene copolymers produced in a high pressure free radical polymerization process and having a density in the range of 0.917 g/cm³ to 0.930 g/cm³.

As used herein, “LLDPE” means linear low density polyethylene—i.e., ethylene homopolymers and ethylene copolymers produced in a gas phase polymerization process polymerization process and having a density in the range of 0.915 g/cm³ to 0.940 g/cm³. LLDPE can be prepared using a variety of catalysts, include metallocene catalysts (mLLDPE).

As used herein, “wt. %” means weight percent.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the disclosure.

### HDPE Composition

The presently disclosed flexible packaging utilizes an HDPE composition as a “core” layer to provide barrier properties for moisture and oxygen.

The HDPE can be a homopolymer or a copolymer. In some embodiments, the HDPE-based composition is a virgin HDPE, a recycled HDPE, or a combination thereof. The HDPE can also have a density between about 0.940-0.965 g/cc and a melt index between about 2-18 g/10 min.

In some embodiments, the HDPE-based composition has at least one nucleating agent. In some embodiments, the HDPE-based composition can also include one or more additional additives. Suitable types of additives for preparing the HDPE-based compositions are, for example, antioxidants, melt stabilizers, light stabilizers, acid scavengers, lubricants, processing aids, antiblocking agents, slip agents, antistatic agents, antifogging agents, pigments or dyes, nucleating agents, flame retardants or fillers. It is common that several additives are added. The multiple additives can be different types of additives. It is however also possible that several representatives of one type of additives are added to the polyethylene composition. Additives of all these types are generally commercially available and are described, for example, in Hans Zweifel, Plastics Additives Handbook, 5th Edition, Munich, 2001.

In some embodiments, the HDPE-based composition has less than 2,000 ppm of additives. In some embodiments, the HDPE-based composition has 200 to 800 ppm of an antioxidant, 100 to 500 ppm of an acid scavenger and 200 to 1700 ppm of a nucleating agent, with the remainder of the composition being at least one HDPE.

### Extrusion Coating

The HDPE-based composition can be layered, or coextruded, with another polymer layer that is situated on a flexible substrate using an extruder. This intermediate layer can be a polyolefin layer, or it can be a multilayered structure with some or all layers being comprised of at least one polyolefin. In some embodiments, the intermediate layer is at least one LDPE. In other embodiments, the HDPE composition is layered directly onto a flexible substrate, with no other intermediate layer coextruded alongside the HDPE composition.

Any known extruder for extrusion coating can be used, including in in particular single screw extruders.

The substrate can be any used in flexible packaging. In some embodiments, the substrate is paper-based such as kraft paper or paperboard. In other embodiments, the substrate is a fiber, including without limitation, wovens, nonwovens, carpet, and spun fibers. In other embodiments, the substrate is a polymer film. In yet other embodiments, the substrate is polyethylene terephthalate, polyamides, polyaramids, biaxially oriented PP (BOPP) and other types of polymers.

In some applications, layered on top of the substrate is an intermediate layer that can be a layer of a single polymer material or a structure with multiple, discrete layers of the same or different materials. In some embodiments, the intermediate layer is a polymer such as polyethylene, polypropylene, polyester, polyvinylchloride, polyamide, and/or polyacrylonitrile. In other embodiments, the intermediate layer is an LDPE.

In some embodiments, the HDPE composition forms a layer that is about 20 to 60% of the total thickness of the layers on the substrate. In other embodiments, the HDPE composition forms a layer is at least 0.5 mil to about 4 mil.

In some embodiments of applying the HDPE composition, the extrusion temperature at the die is between about 300 and about 650° F., or 600 and about 650° F. The line speed is between greater than 0 and 3,000 feet/min, or between about 300 to 3,000 feet/min, or between about 1000 to 2000 feet/min, or between about 400 and 600 feet/min. In other embodiments, the extrusion temperature at the die is about 615° F., and the line speed is about 500 feet/min.

### EXAMPLES

The practice and advantages of the various embodiments, compositions and methods as provided herein are disclosed below in the following examples. These Examples are illustrative only, and are not intended to limit the scope of the appended claims in any manner whatsoever.

A variety of commercially available HDPE grades were selected for extrusion coating alongside a low density polyethylene (LDPE). Table 1 describes the materials used in this example. All resins were obtained from LyondellBasell (Houston, TX).

TABLE 1
Materials used for the extrusion coated samples

| | | | Melt Index | |
|---|---|---|---|---|
| Material | Commercial | Polymer | (190° C., 2.16 | Density |
| name | Grade Name | Type | kg, g/10 min.) | (g/cm³) |
| HD1 | Alathon H6012 | Homopolymer | 12 | 0.960 |
| HD2 | Alathon M6080 | Homopolymer | 7.9 | 0.960 |
| LDPE | Petrothene | Low Density | 5.6 | 0.923 |
| | NA217 | Polyethylene | | |

### Methods

The following methods were used to prepare the extrusion coated samples.

A multi-layer, 30 inch-wide extrusion coating line was used to create the samples. All specimens evaluated in this study were created by coating a polyester film substrate with a three-layer polymer structure. The structure consisted of a barrier layer comprising the presently described HDPE-based composition sandwiched between two LDPE layers, wherein at least one LDPE layer was attached to the substrate. The LDPE layers were 100% low density polyethylene (hereinafter LDPE 1) that was extruded 2 mil thick (˜28 lb/ream). The barrier layer consisted of the various HDPEs grades shown above in Table 1, at various thicknesses of the total packaging. The HDPE was extruded at 20 or 30 mil thickness. During the trials, the extrusion temperature at the die was 615° F., and the line speed was 500 feet/min. The extrusion coating line was allowed to run for 10 minutes at these conditions before samples were taken, to ensure steady state shear conditions were reached.

The resonance time, also called “air gap”, is a processing parameter for extrusion coating. It is the gap between the die and where the molten curtain comes in contact with the substrate. In other words, it is how long the molten polymer is in contact with air. For the examples described below, the air gap was either 7 or 11 inches.

The WVTR of the film with the HDPE barrier layer was measured according to ASTM F1249.

### Example 1

In one set of experiments, the barrier layer had a 30 mil die and different air gaps. Table 2 displays details of these samples.

TABLE 2
7 in air gap, 30 mil die, 30% core

| Thickness (mil) | 0.7 | 0.6 | 0.7 |
|---|---|---|---|
| Sample 1 | LDPE | HD1 | LDPE |
| Sample 3 | LDPE | HD2 | LDPE |

11 in air gap, 30 mil die, 30% core

| Thickness (mil) | 0.7 | 0.6 | 0.7 |
|---|---|---|---|
| Sample 2 | LDPE | HD1 | LDPE |
| Sample 4 | LDPE | HD2 | LDPE |

7 in air gap, 30 mil die, 50% core

| Thickness (mil) | 0.5 | 1.0 | 0.5 |
|---|---|---|---|
| Sample 5 | LDPE | HD1 | LDPE |
| Sample 7 | LDPE | HD2 | LDPE |

11 in air gap, 30 mil die, 50% core

| Thickness (mil) | 0.5 | 1.0 | 0.5 |
|---|---|---|---|
| Sample 6 | LDPE | HD1 | LDPE |
| Sample 8 | LDPE | HD2 | LDPE |

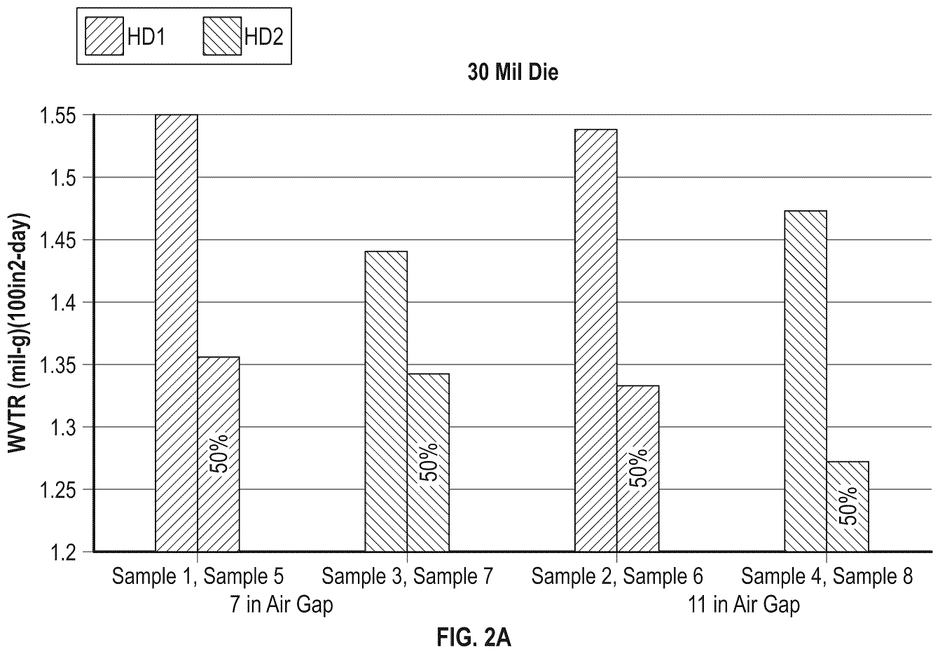

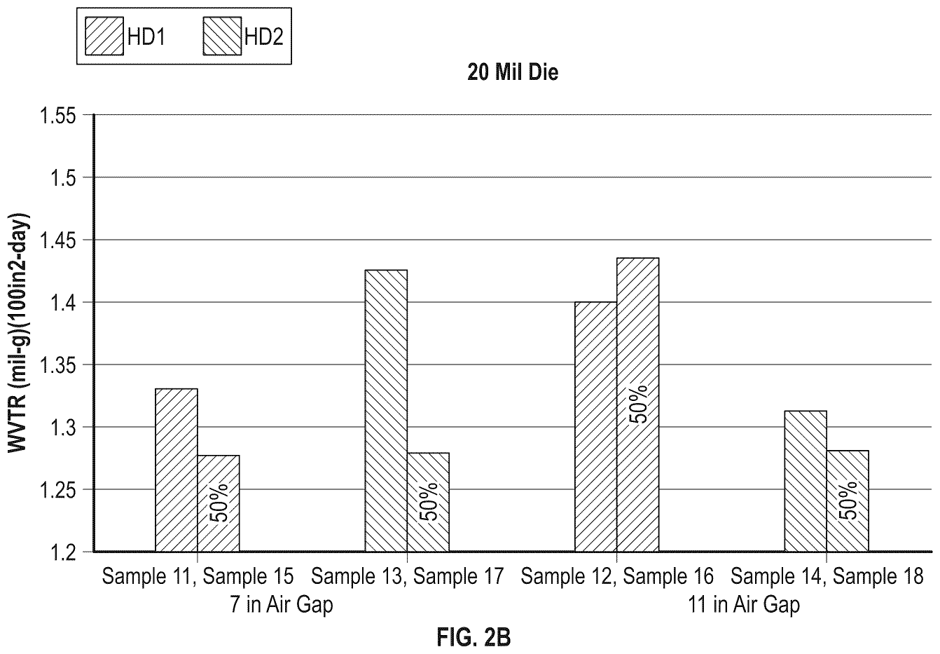

The results for the WVTR tests are shown in FIG. 2A. The HD2 gave consistently improved moisture barrier compared to HD1. Increasing the HD core percentage from 30 to 50% significantly improved the moisture barrier as well. Overall, raising the air gap and increasing the resonance time allowed for some improvement in WVTR.

### Example 2

In view of the results of Example 1, samples with a barrier layer of 20 mil die and different air gaps were prepared. Table 3 displays details of these samples.

TABLE 3
7 in air gap, 20 mil die, 30% core

| Thickness (mil) | 0.7 | 0.6 | 0.7 |
|---|---|---|---|
| Sample 11 | LDPE | HD1 | LDPE |
| Sample 13 | LDPE | HD2 | LDPE |

11 in air gap, 20 mil die, 30% core

| Thickness (mil) | 0.7 | 0.6 | 0.7 |
|---|---|---|---|
| Sample 12 | LDPE | HD1 | LDPE |
| Sample 14 | LDPE | HD2 | LDPE |

7 in air gap, 20 mil die, 50% core

| Thickness (mil) | 0.5 | 1.0 | 0.5 |
|---|---|---|---|
| Sample 15 | LDPE | HD1 | LDPE |
| Sample 17 | LDPE | HD2 | LDPE |

11 in air gap, 20 mil die, 50% core

| Thickness (mil) | 0.5 | 1.0 | 0.5 |
|---|---|---|---|
| Sample 16 | LDPE | HD1 | LDPE |
| Sample 18 | LDPE | HD2 | LDPE |

The results for the WVTR tests are shown in FIG. 2B. HD2 gave consistently improved moisture barrier over HD1, as expected in view of Example 1. Increasing the HD core percentage significantly improved the moisture barrier as well. Finally, raising the air gap did not have as big of an impact as the tighter die gap (50% core).

### Example 3

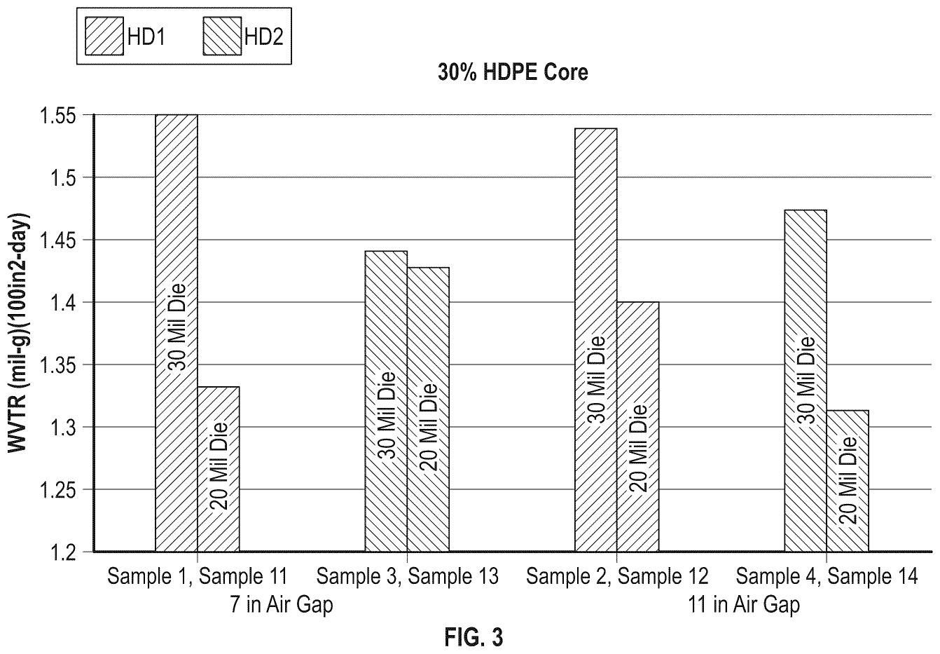

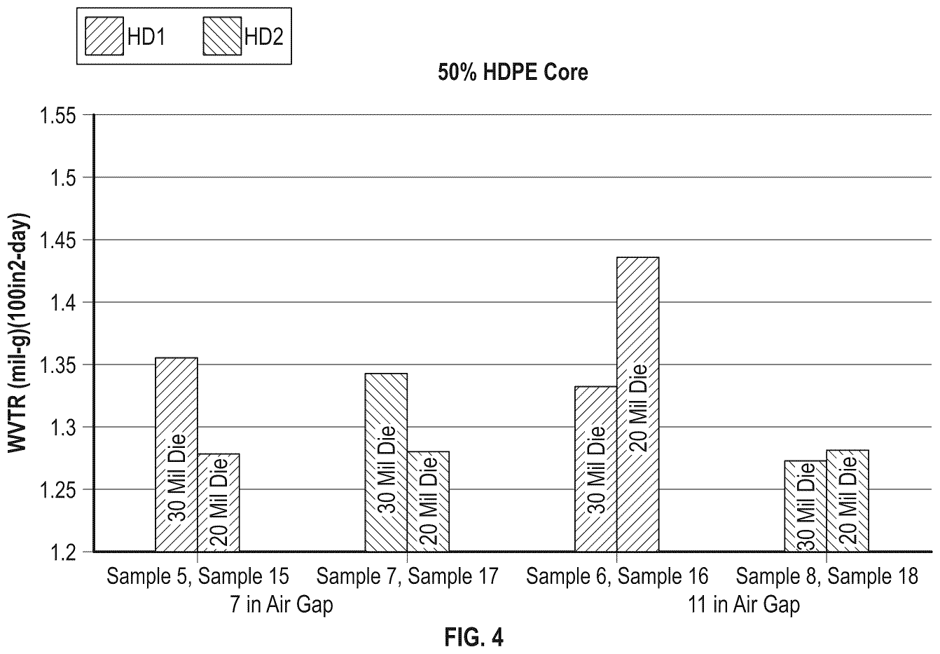

The WVTR results were also investigated for the different HD layer thicknesses. The results for the 30% HD barrier layer is shown in FIG. 3 and the results for a 50% HD barrier layer is shown in FIG. 4. Tightening the die, or increasing the shear rate applied to the polymer, assisted in improving the overall moisture barrier for both loadings.

In conclusion, HDPE could be used as a barrier layer in extrusion coating applications to improve WVTR and OTR of a flexible packaging without the use of a foil barrier layer. Increasing the HDPE loading resulted in better moisture barrier. Thus, one with skill in the art can select loadings (e.g. thicknesses) and processing conditions to create flexible packaging with their desired moisture control.

What is claimed is:

1. A flexible packaging comprising:
a. a substrate;
b. a barrier layer comprising a high density polyethylene (HDPE); and,
c. an intermediate layer between said substrate and said barrier layer,
wherein said flexible packaging has a water vapor transmission rate below 2 (mil-g)(100 in²-day) at 50 mil or less thickness.

2. The flexible packaging of claim 1, wherein the intermediate layer comprises at least one polymer.

3. The flexible packaging of claim 1, wherein the intermediate layer comprises a low density polyethylene (LDPE).

4. The flexible packaging of claim 1, wherein the HDPE has a melt index between 2-18 g/10 min.

5. The flexible packaging of claim 1, wherein the HDPE has a melt index between 8-18 g/10 min.

6. The flexible packaging of claim 1, wherein the barrier layer comprises at least one HDPE, at least one antioxidant, at least one acid scavenger, and at least one nucleating agent.

7. The flexible packaging of claim 1, wherein the barrier layer comprises a HDPE homopolymer, copolymer, or combination thereof.

8. The flexible packaging of claim 1, wherein the barrier layer comprises a virgin or recycled HDPE.

9. The flexible packaging of claim 1, wherein the barrier layer is between 20 and 60% of the thickness of the flexible packaging.

10. The flexible packaging of claim 1, further comprising an outer polymer layer, wherein the barrier layer is sandwiched between the outer polymer layer and said intermediate layer.

11. The flexible packaging of claim 1, wherein the intermediate layer comprises at least one polymer.

12. The flexible packaging of claim 1 having an oxygen transmission rate (OTR) of below about 21 (mil-g)(100 in²-day).

13. A method of making a flexible packaging, comprising extruding a barrier layer comprising a high density polyethylene onto a flexible substrate.

14. The method of claim 10, wherein said flexible packaging has an intermediate layer between said barrier layer and said flexible substrate.

15. The method of claim 10, wherein said barrier layer is co-extruded with an intermediate polymer layer, wherein the intermediate polymer layer is sandwiched between said barrier layer and said flexible substrate.

16. A method of making a flexible packaging, comprising co-extruding a barrier layer and an intermediate layer onto a flexible substrate, wherein said intermediate layer is between said substrate and said barrier layer.

17. The method of claim 13, further comprising co-extruding an outer polymer layer with said a barrier layer and said intermediate layer, wherein the barrier layer is between said outer polymer layer and said intermediate layer.
